(19) United States
(12) Patent Application Publication
(10) Pub. No.: US 2025/0148796 A1
(43) Pub. Date: May 8, 2025

(54) METHOD FOR DETECTING AND COUNTING INDIVIDUALS IN A CROWD

(71) Applicant: IDEMIA IDENTITY & SECURITY FRANCE, Courbevoie (FR)

(72) Inventors: Pierre PERRAULT, Courbevoie (FR); Siwar MHADHBI, Courbevoie (FR)

(73) Assignee: IDEMIA IDENTITY & SECURITY FRANCE, Courbevoie (FR)

(21) Appl. No.: 18/891,008

(22) Filed: Sep. 20, 2024

(30) Foreign Application Priority Data
Sep. 29, 2023 (FR) 2310410

(51) Int. Cl. G06V 20/52; G06V 10/82; G06V 40/10

(52) U.S. Cl. CPC G06V 20/53; G06V 10/82; G06V 40/10

(57) ABSTRACT

A method, implemented by computer, for locating and counting individuals in a crowd, said method takes, as input data, one or more images of a crowd of individuals, and provides, as output data, one or more binary images of connected components corresponding to the heads of the individuals of the crowd including providing a convolutional neural network previously trained on a training set of images of crowds of individuals whose heads are annotated, the annotations having previously been modified using a process of tiling as adjacent cells, generating, for each image of a crowd, a prediction map processing said image through the convolutional neural network, binarizing each prediction map using a binarization module configured to generate a threshold value or a map of threshold values specific to said prediction map PM, each binarized prediction map being a binary image of connected components corresponding to the heads of the individuals.

### TECHNICAL FIELD

The present invention relates to a method and a system for detecting and counting individuals forming a crowd.

### TECHNICAL BACKGROUND

The detection and the counting of the individuals forming a crowd in common spaces accommodating the public, such as streets, stations, airports, town squares, forums, places of pilgrimage, exhibition locations, concert halls and other events, today form parts of the actions on which the so-called reasoned management of crowds is based. This reasoned management covers the implementation of a certain number of information-gathering, organization, equipment and logistics means. These means range, for example, from simple journalistic reporting for an audience measurement to administrative or police public security and safety measures, through regulation of the frequenting of the sites or even the evacuation of the people in the event of incidents. Statistical studies founded on these actions can also provide essential information for establishing and/or optimizing evacuation plans in the event of fire, designing arrangements suited to spaces or even organizing traffic circuits to fluidize the movements of the crowd. They also form a framework of study, of modelling and of anticipation of the collective behaviors during crowd movements.

Crowds have very diverse spatial densities and distributions, and are generally not homogeneous. They can notably be spread around pieces of furniture, building elements, landscape elements such as trees and shrubs, or other objects, such as parked or moving vehicles. As an example, a crowd may simply be composed of a group of scattered pedestrians moving along in a street, a dense group of runners or walkers in a marathon or a demonstration, or even a group of individuals who are substantially static during a concert or a festival.

Various methods for detecting and counting crowds are currently developed. Some of them are based on artificial vision tools (“computer vision”), notably on the analysis of images or video sequences acquired by acquisition devices previously disposed in the common spaces. Others make use of the signals from the various mobile electronic telecommunication devices with which people these days are equipped, or the variations of the telecommunications signals provoked by the variation of the number of individuals or their movement. Yet others combine the analysis of several sources of information from the images or video sequences to the telecommunications signals, through thermal mappings.

CN 102750539 A, SHENZHEN HIETECH ENERGY TECHNOLOGIES CO LTD, Oct. 24, 2012 describes a method for counting individuals based on the analysis of video images and of infrared images.

WO 2016 155769 A1, TELECOM ITALIA SPA [IT], Oct. 6, 2016 describes a method for counting individuals in a geographic zone during a given period based on the signals from the mobile telecommunication devices with which the individuals are equipped.

CN 107657226 A, UNIV ELECTRONIC SCI & TECH CHINA, Feb. 2, 2018 describes a method for counting individuals in a crowd based on a convolutional neural network trained on the Shanghai Tech annotated training dataset.

CN 116012335 A, SHANDONG UNIVERSITY OF SCIENCE & TECHNOLOGY, Apr. 25, 2023 describes a method for counting individuals of a crowd based on the combined analysis of images of the crowd and information on the status of the channels of the Wi-Fi signal deployed in the room in which the crowd is located.

The main drawback with the methods based on the exclusive or partial use of telecommunications signals is that they rely on third-party databases, access to which is not always easy with the telecommunication operators. Furthermore, in order to preserve the confidentiality and the privacy of people, these data often require preliminary anonymization processing for which the absence of data leaks is never however fully guaranteed. For these reasons, these methods, however powerful they may be, are rarely used, and those based on the analysis of images or of video sequences are prioritized.

Among the methods involving artificial vision tools, the heuristic algorithms configured to locate the heads of the individuals in a density map or a prediction map provide highly promising results, notably since large annotated training datasets such as Shanghai Tech, UCF-QNRF or NWPU-Crowd are available.

In this respect, Gao et al., Learning Independent Instance Maps for Crowd Localization, arXiv preprint arXiv: 2012.04164 (2020), describes a method for locating and counting individuals in a crowd in which a heuristic approach is combined with a binary semantic segmentation into connected components surrounding or encompassing the heads of the individuals. This method implements a network of HRNet (“High-Resolution Network”) type or of VGG (“Visual Geometry Group”) type combined with an FPN (“Feature Pyramid Network”) previously trained on a set of images of crowds in which the heads of the individuals are annotated using boxes which, when they are superposed, are redimensioned such that the distance separating them is greater than a quarter of their width or of their height. Before the learning, for each image, the corresponding annotations are used to create a binary image, called “Independent Instance Maps” (IIM): the value of the pixels of the regions of the images corresponding to the boxes are set at 1, that of the pixels corresponding to their background is set at 0. These IIM binary images are used to supervise the training of a semantic segmentation task, via a loss function of MSE type.

The neural network produces prediction maps, also called confidence maps, in which the values of the pixels are probabilities of belonging or of not belonging to a region of the heads of the individuals. The method further comprises a binarization module configured to produce a thresholding of the prediction maps using a thresholding map predicted on the fly by a suitable encoder. At the end of this processing, the connected components are detected on the binary maps produced and are modelled in the form of encompassing boxes.

### SUMMARY OF THE INVENTION

### Technical Issue

The method described by Gao et al., Learning Independent Instance Maps for Crowd Localization, arXiv preprint arXiv: 2012.04164 (2020) makes it possible to improve the detection and the counting of the individuals in images of dense crowds in which the sizes and the scales vary greatly because of perspective effects.

However, this method suffers the major drawback of underestimating the number of individuals, notably when the crowds have a very great density of individuals. This drawback has several origins. It has been found that some of the boxes corresponding to the heads of the individuals can be considered by the algorithm to be “too small” and be unjustly eliminated. Sometimes, in particular for particularly dense crowds, the method does not manage to correctly separate the boxes when they are superposed. Even when it does achieve this, if the boxes are too close to one another, they ultimately end up being merged together by inference.

### Technical Solution

In a first aspect of the invention, a method is provided, implemented by computer, for locating and counting individuals in a crowd, said method takes, as input data, one or more images of a crowd of individuals, and provides, as output data, one or more binary images of connected components corresponding to the heads of the individuals of the crowd, said method comprises the following steps:
(a) providing a convolutional neural network previously trained on a training set composed of images of crowds of individuals whose heads are annotated, the annotations of each image of said training set having previously been modified using a process of tiling as adjacent cells;
(b) generating, for each image of a crowd supplied as input data, a prediction map by processing said image through the convolutional neural network supplied in step (a);
(c) binarizing each prediction map generated in step (b) using a threshold value or a map of threshold values, each binarized prediction map being a binary image of connected components corresponding to the heads of the individuals.

Other advantageous embodiments are described hereinbelow.

In a second aspect of the invention, a data processing device is provided for the implementation of a method according to the first aspect of the invention.

In a third aspect of the invention, a computer program is provided comprising instructions which, when the program is run by a computer, cause the latter to implement a method according to the first aspect of the invention.

In a fourth aspect of the invention, a computer-readable storage medium is provided comprising instructions which, when they are executed by a computer, cause the latter to implement a method according to the first aspect of the invention.

In a fifth aspect of the invention, a system is provided for the implementation of a method according to the first aspect of the invention.

### BRIEF DESCRIPTION OF THE DRAWINGS

FIG. 1 is an image of a crowd of individuals.

FIG. 2 is a flow diagram of a method according to the first aspect of the invention.

FIG. 3 is an image of a crowd of individuals after a process of tiling as adjacent cells in accordance with the first aspect of the invention.

FIG. 4 is a schematic representation of a tiling as adjacent cells.

FIG. 5 is an example of a binary image of connected components corresponding to the heads of the individuals obtained using a method according to the first aspect of the invention applied to FIG. 1.

FIG. 6 is a schematic representation of annotations of the head of an individual in an image of a crowd.

FIG. 7 is a schematic representation of a reduction of the size of annotation boxes in superposed condition.

FIG. 8 is an example of a binary image obtained at the end of a tiling process applied to FIG. 3.

FIG. 9 is a schematic representation of a tiling as adjacent cells after reduction into sub-cells.

FIG. 10 is an image of a crowd of individuals whose heads are marked using dots corresponding to the centers of gravity of rectangular boxes encompassing the heads.

FIG. 11 is the image of a crowd of FIG. 10 after a process of tiling as adjacent cells.

FIG. 12 is the image of FIG. 11 after reduction of the adjacent cells into sub-cells.

FIG. 13 is the image of FIG. 12 in which the heads of the individuals are annotated using rectangular boxes encompassing the heads.

FIG. 14 is a binary image obtained from FIG. 12 by the intersection of the sub-cells with the rectangular boxes forming annotations.

FIG. 15 is a schematic representation of a data processing device for the implementation of a method according to the first aspect of the invention.

### DETAILED DESCRIPTION OF THE EMBODIMENTS

Within the meaning of the present invention, an “image of a crowd of individuals” should be understood to mean an image, such as a photograph or a video clip, on which a plurality of individuals is represented whose heads and possibly certain elements of the face are visible or discernible. The density of individuals, that is to say the number of individuals per unit of surface area in the image, is variable. A crowd is generally said to be not very dense when the number of individuals in the image lies between 25 and 100, it is said to be moderately dense when the number lies between 100 and 250, and it is said to be very dense when the number is greater than 250. Preferably, the images are crowd images in perspective in which the individuals are at different depths of field.

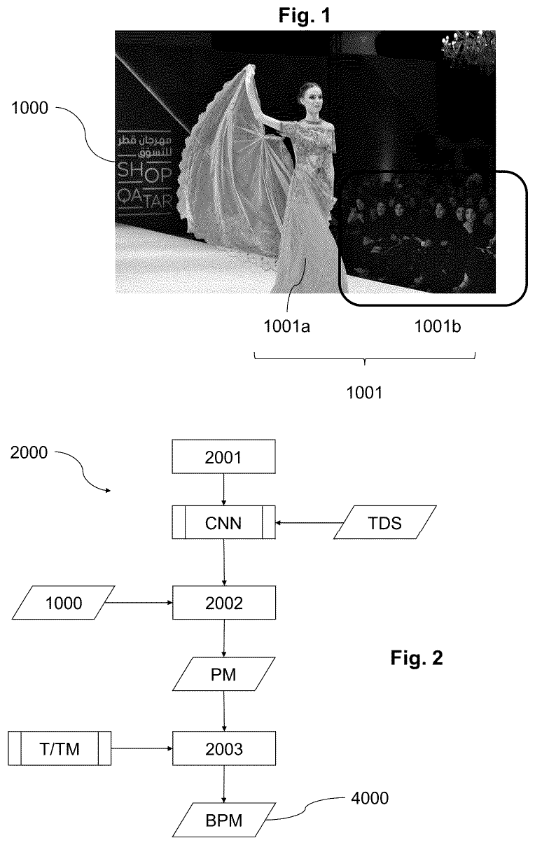

An example of an image 1000 of a crowd 1001 in perspective is represented in FIG. 1. A first individual 1001a appears in the foreground in the middle of the image, and a denser group of individuals 1001b can be seen on the right in the background. Their heads and some elements of their faces are discernible.

Referring to FIGS. 1 to 5, according to a first aspect of the invention, a method 2000 is provided, implemented by computer, for locating and counting individuals in a crowd 1001, said method 2000 takes, as input data, one or more images 1000 of a crowd 1001 of individuals, and provides, as output data, one or more binary images 5000 of connected components 5001a-z corresponding to the heads of the individuals of the crowd 1001, said method 2000 comprises the following steps:
(a) providing 2001 a convolutional neural network CNN previously trained on a training set TDS composed of images 3000 of crowds 3001 of individuals whose heads 3001a-z are annotated, the annotations of each image of said training set TDS having previously been modified using a process of tiling as adjacent cells 3002a-z;
(b) generating 2002, for each image 1000 of a crowd supplied as input data, a prediction map PM by processing said image 1000 through the convolutional neural network CNN provided in step (a);
(c) binarizing 2003 each prediction map PM generated in step (b) using a threshold value T or a map of threshold values TM specific to said prediction map PM, each binarized prediction map BPM being a binary image 5000 of connected components 5001a-z corresponding to the heads of the individuals.

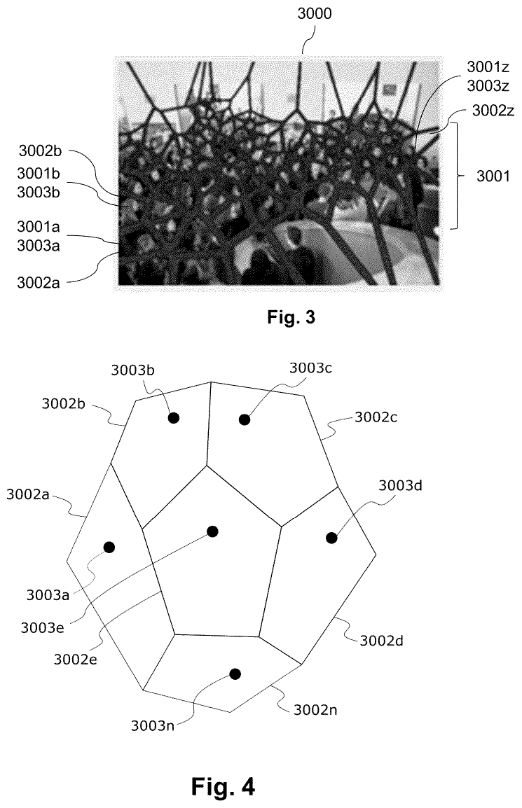

Referring to FIG. 3, in step (a), a convolutional neural network CNN is trained on a training dataset TDS composed of images 3000 of crowds 3001 of individuals whose heads 3001a-z are annotated. The annotation of the heads is generally done manually or automatically in the form of distinctive symbols applied to the image so as to identify and locate the heads. The annotations can be incorporated directly in the image or, more usually, be supplied in the form of masks, for example bit masks, which, when they are superposed on the images, identify and locate the heads. The distinctive symbols forming the annotations can take different forms.

Referring to FIG. 6, according to one embodiment, in step (a), the heads 3001a of the individuals of the images 3000 of the training set TDS are annotated using boxes 6000 encompassing said heads 3001a-z. FIG. 6 is deliberately simplified for purely illustrative purposes so as to represent only a single head surrounded by an annotation box. For a complete crowd of individuals, a box surrounds each of the heads. An example of a training set comprising annotations in box form encompassing the heads is the set NWPU-Crowd, which can advantageously be used for the training of the convolutional neural network CNN of said step (a).

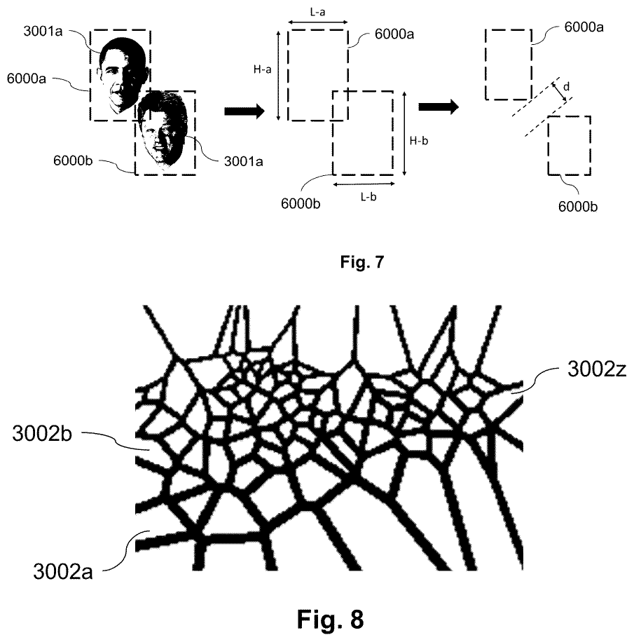

Referring to FIG. 7, according to another embodiment, in step (a), the heads 3001a-z of the individuals of the images 3000 of the training set TDS are annotated using boxes 6000 centered on said heads 3001a-z, the sizes of the boxes 6000a, 6000b in superposed condition are reduced such that the distance, d, separating them is greater than a quarter of their smallest dimension, L-a, L-b, H-a, H-b. As an example, for boxes of rectangular form like those illustrated in FIG. 7, the boxes 6000a, 6000b in superposed condition can be reduced such that the distance d separating them is greater than a quarter of their smallest dimension out of their width L-a, L-b or their height H-a, H-b. FIG. 7 is deliberately simplified for purely illustrative purposes so as to represent only two heads, each surrounded by a rectangular annotation box.

The operation of reducing the size of the annotation boxes can be implemented on any type of suitable training set such as, for example, the sets Shanghai Tech and UCF-QNRF. It has been found that this operation before the tiling process improved the performance levels of the method with respect to the locating and the counting of the heads.

Referring to FIG. 3, in step (a), the annotations of each image of said training set TDS have previously undergone a process of tiling as adjacent cells 3002a-z. The tiling process is of any appropriate type and allows for a breakdown of the space of the images into adjacent cells.

According to a preferred embodiment, in this step (a), the tiling is a Voronoi breakdown, also called Dirichlet tessellation. The cells obtained using such a breakdown are commonly called Voronoi polygons or Thiessen polygons. In this type of tiling, each adjacent cell 3002a-z has for its centroid 3003a-z a single dot of the image representative of the head 3001a-z of an individual and is formed by adjacent dots of the image 3000 closest to said centroid 3003a-z. It has been found that a process of tiling according to a Voronoi breakdown provided advantageous performance levels.

As an example, the tiling process on the annotations can be implemented as follows. First of all, each image 3000 is the subject of a breakdown into adjacent cells 3002a-z, each adjacent cell 3002a-z having for its centroid 3003a-z a single dot of the image representative of the head 3001a-z of an individual and is formed by adjacent dots of the image 3000 closest to said centroid 3003a-z. The single dot representative of the head 3001a-z of an individual serving as centroid 3003a-z can be the center of a head and be obtained from annotations of the image 3000. Next follows an operation of intersection between each cell of the breakdown into adjacent cells and the annotations such as encompassing boxes. The function of the intersection operation is to produce modified annotations from which a binary image can be derived, in which the pixels have a value 1 (white pixels) if the pixels belong to the modified annotations or a value 0 (black pixels) if the pixels are outside of said annotations.

The convolutional neural network CNN trained in step (a) is of any suitable type. According to a preferred embodiment, the convolutional neural network CNN is an HRNet convolutional neural network. An example of a convolutional neural network of HRNet type is described in Wang et al. “Deep high-resolution representation learning for visual recognition.” IEEE transactions on pattern analysis and machine intelligence 43.10 (2020): 3349-3364.

In step (b), the convolutional neural network CNN is applied to each image of a crowd 1000 supplied as input data of the method 2000. A prediction map PM, also called inference map, is generated for each image 1000, which prediction map generally takes the form of an image in which the value of the pixels is a probability of presence of a head identified and located by the convolutional neural network CNN.

In step (c), each prediction map PM is binarized using a threshold value T or a map of threshold values TM specific to said prediction map PM, each binarized prediction map BPM being a binary image 5000 of connected components 5001a-z corresponding to the heads of the individuals.

Typically, as an example, the threshold value T or a threshold map TM can be generated by a binarization module from a “features map” extracted from the convolutional neural network CNN used to generate the prediction map PM from the image 1000 supplied as input.

In an exemplary embodiment, a binarization module BM can comprise
an adaptive encoder in the form of a convolutional neural network BM-CNN trained to generate, for each prediction map PM, a threshold value T or a threshold map TM from a features map provided by the convolutional neural network CNN applied in step (b) to the image 1000 to generate said prediction map PM, and
a binarization layer in the form of a convolutional neural network configured to generate a binarized prediction map BPM from the prediction map PM generated in step (b) and the threshold value T or the threshold map TM generated by the adaptive encoder from said prediction map.

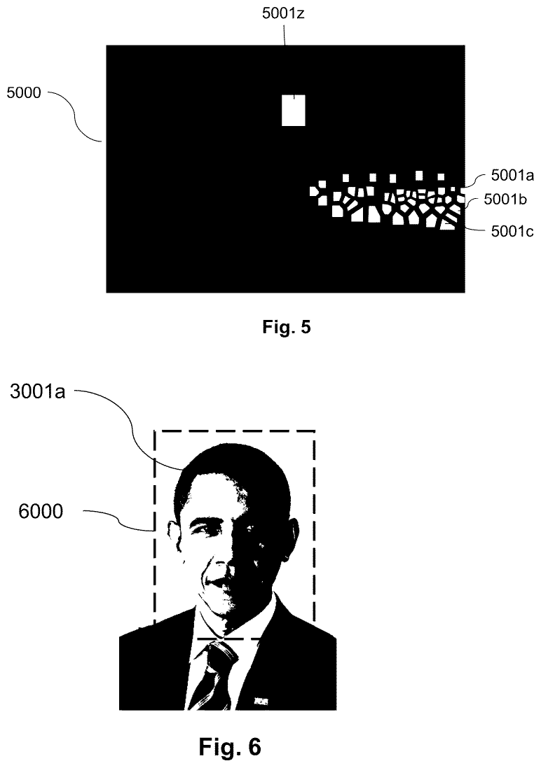

FIG. 5 represents an example of an image 5000 of connected components 5001a-z obtained from the image of FIG. 1 to which the method according to the first aspect of the invention has been applied. In the context of the present invention, connected components are understood to be the connected components as defined in mathematical topology. In FIG. 5 each connected component is formed by the space of the image corresponding to an individual head such that it is located by the method according to the first aspect of the invention.

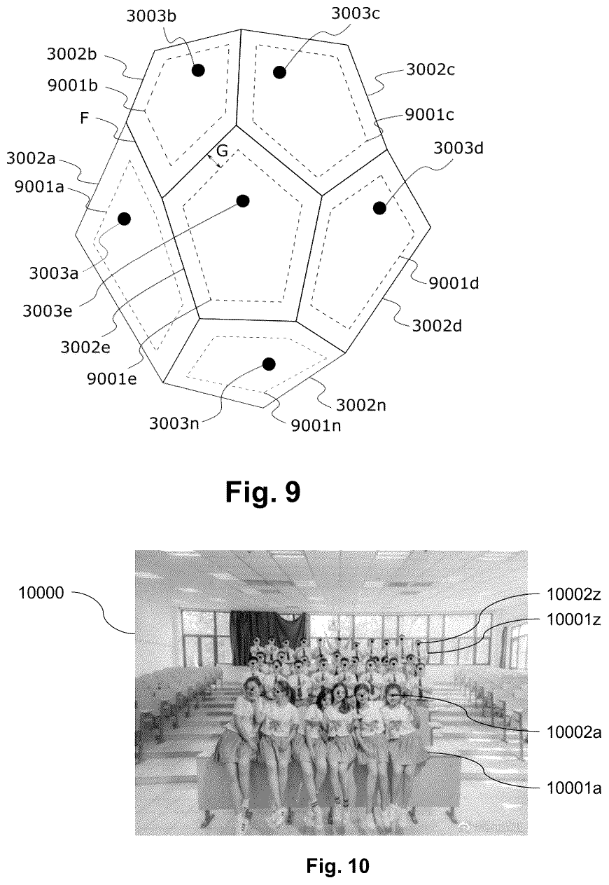

Referring to FIG. 9, according to certain preferred embodiments, in step (a), the tiling process comprises the reduction of each adjacent cell 3002a-z into a sub-cell 9001a-z, said sub-cell 9001a-z is inscribed in said adjacent cell 3002a-z and is separated from the other adjacent cells 3002a-z at the boundary F between said adjacent cell and the other adjacent cells by a separation zone G of a given width.

The reduction of the cells 3002a-z into sub-cells 9001a-z makes it possible to reduce the connectedness of the cells by the replacement of the tiling as adjacent cells with a sub-tiling composed of separate and distinct sub-cells having for their centroid the same single dots of the image representative of the head of an individual as that of the adjacent cells. It has been found that such a sub-tiling contributes to a more accurate learning of the convolutional neural network CNN in the identification and the counting of the heads of the individuals in an image of a crowd.

The width of the separation zone G can be set or variable. When set, it can be defined by a constant value previously chosen and applied uniformly to all the sub-cells. When variable, it can be adapted to each sub-cell according to certain features of the first neighbor adjacent cells.

As illustrated in FIG. 9, by taking the example of the sub-cell 9001e, the width of the separation zone G is the width between the outlines of said sub-cell 9001e and those of the adjacent cells 3002a, b, c, d, n to the cell 3002e in which said sub-cell 9001e is inscribed. The sub-cell 9001e and the cell 3001e of which it is the reduction and in which it is inscribed have the same centroid 3003e. The total width of the separation zone between two adjacent sub-cells, for example between the two sub-cells 9001e and 9001b, is therefore equal to twice this width when it is set for all the sub-cells or to the sum of the separation widths on either side of the boundary F of the adjacent cells 3002b and 3002e when it is variable.

According to a particular embodiment, the width of the separation zone G is set. It is at most 5 pixels, preferably at most 2 pixels, even at most 1 pixel. It has been found that these values allow for an advantageous separation of the sub-cells without reducing their size excessively. In its training on the training set, the convolutional neural network CNN benefits both from a maximum quantity of information relating to the zones of the images corresponding to the heads of the individuals and from an adequate separation to improve its ability to discern the heads in possibly superposed condition.

According to other particular embodiments, the width of the separation zone varies for each sub-cell 9001e according to either certain features of the first neighbor adjacent cells 3002a, b, c, d, n, or certain features of the adjacent cell 3001e of which it is the reduction and in which it is inscribed.

According to a first particular embodiment, for each sub-cell 9001a-z, the width of the separation zone G is less than or equal to an eighth of the minimum value out of the geometrical dimensions of the annotations 6000 corresponding to the first neighbor adjacent cells of the adjacent cell in which the sub-cell is inscribed, the number of first neighbor cells being at least 3, preferably at least 5. FIG. 8 provides an example of a binary image in which the width of the separation zone G between the sub-cells is in accordance with this particular embodiment. The variations of width are illustrated by the variation of the thickness of the boundaries between the cells 3002a-z.

According to a second particular embodiment, the area of the intersection of each sub-cell 9001a-z with the annotation 6000 associated with the adjacent cell 3002a-z in which said sub-cell 9001a-z is inscribed is greater than or equal to half the area of said annotation 6000.

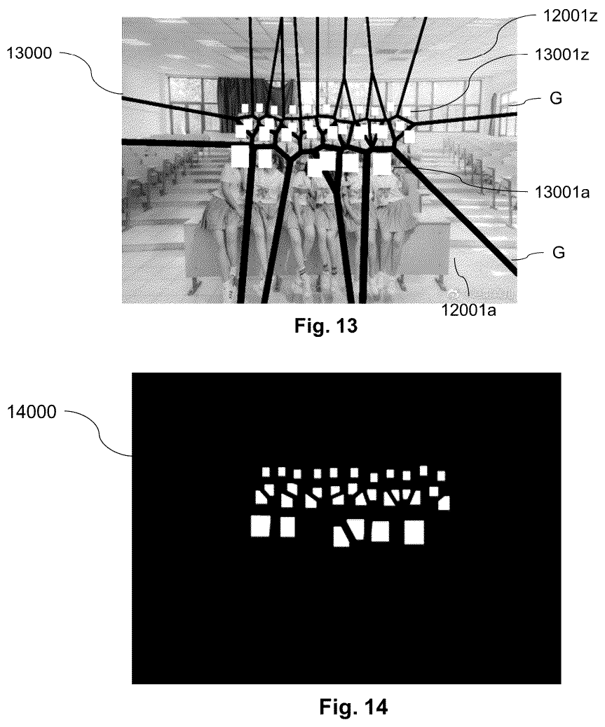

A detailed example of the tiling process in accordance with certain embodiments of the first aspect of the invention is illustrated in FIGS. 10 to 14. Referring to FIG. 10, an image 10000 of a crowd of individuals 10001a-z is provided in which the heads of said individuals 10001a-z are marked using dots 10002a-z. These dots correspond to the center of gravity of annotations in the form of rectangular boxes encompassing said heads. These rectangular boxes 13001a-z are illustrated in FIG. 13.

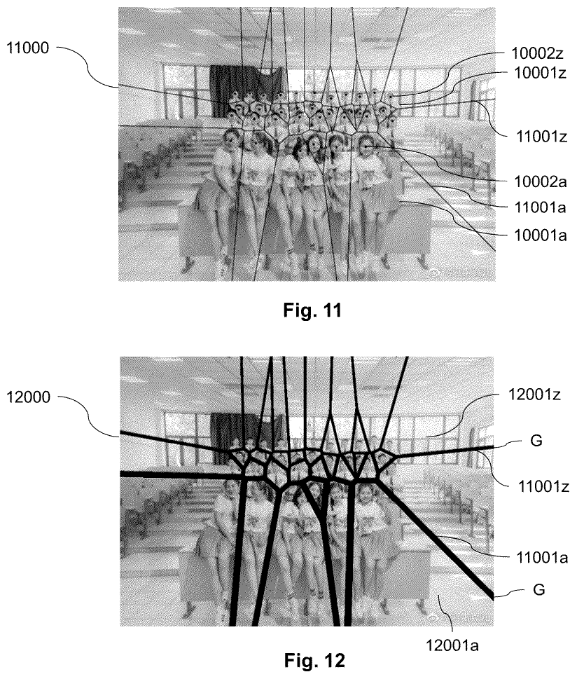

Referring to FIG. 11, the image 10000 of FIG. 10 is subjected to a tiling process to form a second image 11000 broken down into adjacent cells 11001a-z, each adjacent cell 11001a-z having for its centroid a single dot 10002a-z of the image representative of the head of an individual 10001a-z and is formed by adjacent dots of the image 11000 closest to the said centroid. In this particular case, the single dot representative of the head of an individual 10001a-z serving as centroid is composed of the dot the 10002a-z marking the head of the individual 100001a-z.

Referring to FIG. 12, the adjacent cells 11001a-z of the image 11000 are then reduced to sub-cells 12001a-z. Each sub-cell 12001a-z is inscribed in the adjacent cell 11001a-z of which it is the reduction. It is also separated from the other adjacent cells 11001a-z by a separation zone G of a given width. In the present example, the width of the separation zone G is equal to an eighth of the minimum value out of the geometrical dimensions of the annotations 13001a-z corresponding to the first neighbor adjacent cells of the adjacent cell in which the sub-cell is inscribed. The number of first neighbor cells is equal to 5. As indicated previously, with reference to FIG. 13, the annotations are rectangular boxes 130001a-z encompassing the heads of the individuals. In FIG. 13, the sub-cells 12001a-z are also represented, for illustration purposes.

Then follows the intersection of the sub-cells 12001a-z with the rectangular boxes 13001a-z forming the annotations. As explained previously, the function of the intersection operation is to produce modified annotations from which a binary image can be derived, in which the pixels have a value 1 (white pixels) if the pixels belong to the modified annotations or a value 0 (black pixels) if the pixels are outside of said annotations. The binary image 14000 derived from the intersection of the sub-cells 12001a-z with the boxes 13001a-z of annotations is represented in Ia FIG. 14. In this figure, the boxes 13001a-z of annotations appear truncated. The truncated parts of the boxes 13001a-z correspond to the parts of said boxes in superposed condition with the separation zones G between the sub-cells 120001a-z.

In the training of a convolutional neural network, it is routine practice to make use of an objective function, also called “loss function” or “cost function”, to quantify the deviation from the optimal solution. This function can comprise a number of terms including at least one term making it possible to characterize the deviation between an annotated image and a prediction map generated by the convolutional neural network from the same, non-annotated image in its training. An example of an objective function can be a function of “pixel-wise” type L2, also called pixel-wise root mean square error, or of “pixel-wise” “cross-entropy” type between the annotated image and the prediction map.

According to some embodiments, in step (a), the training of the convolutional neural network CNN comprises the use of an objective function, said objective function comprises a penalty parameter associated with the pixels of the image situated on the common boundaries F of the adjacent cells 3001a-z and/or in the separation zones G between sub-cells 9001a-z.

According to an exemplary embodiment, the objective function can comprise several terms, such as root mean square differences, associated with each pixel of the image, each of the terms is assigned a penalty parameter in the form of a weighting factor whose value is higher when the pixels of the annotated image having undergone a tiling process and the pixels of the prediction map obtained from said image are situated on the common boundaries of the adjacent cells of said image and/or in the separation zones of said adjacent cells. The value of the weighting factor can be set empirically or by a mathematical optimization method.

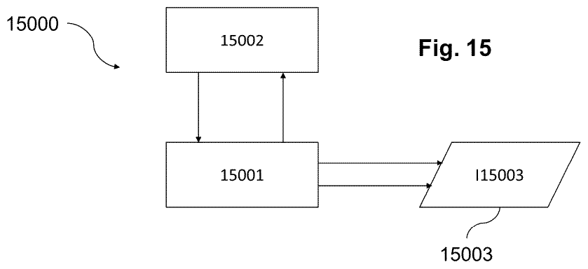

The method according to the first aspect of the invention is implemented by computer. Referring to FIG. 15, according to a second aspect of the invention, a data processing device 15000 is provided comprising means for the implementation of a method according to any one of the embodiments of the first aspect of the invention.

One example of a means for executing the method is a device which can be charged with automatically executing sequences of arithmetic or logic operations to perform tasks or actions. This device, also called computer, can comprise one or more central processing units (CPU) and/or one or more graphics processors (GPU) 15001 and at least one control device adapted to execute these operations. It can also comprise other electronic components such as input/output interfaces 15002, non-volatile or volatile storage devices 15003, and communication buses for the transfer of data between the internal components of the device or with external components. One of the input/output devices 15002 can be a user interface for human-machine interaction, for example a graphical user interface for displaying information that can be understood by people.

According to a third aspect of the invention, it is a computer program I15003 comprising instructions which, when the program is run by a computer, cause the latter to implement a method according to any one of the embodiments of the first aspect of the invention.

Any type of programming language, compiled or interpreted, can be used to implement the steps of the method of the invention. The computer program can form part of a software solution, that is to say a collection of executable instructions, codes, scripts or the like, and/or databases.

According to a fourth aspect of the invention, a computer-readable storage medium 15003 is provided comprising instructions which, when they are executed by a computer, cause the latter to implement a method according to any one of the embodiments of the first aspect of the invention.

The computer-readable storage medium 15003 is preferably a non-volatile memory, for example a hard disk or a semiconductor reader. It can be a removable storage medium or a non-removable storage medium forming part of a computer.

The computer-readable storage medium 15003 can also be a volatile memory inside a removable medium. That can facilitate the roll-out of the invention in many production sites.

The computer-readable storage medium 15003 can form part of a computer used as a server from which executable instructions can be downloaded and, when they are executed by a computer, make the computer execute a method according to one of the embodiments described in the present document.

The computer program I15003 and the medium 15003 on which it is stored can be implemented in a distributed computing environment, for example cloud computing. The instructions can be executed on a server to which one or more client computers can connect and supply coded data as input data of a method according to any one of the embodiments of the first aspect of the invention. Once the data is processed, the result can be downloaded and decoded on the client computer or be sent directly, for example, in the form of instructions.

According to a fifth aspect of the invention, a system for locating and counting individuals in a crowd is provided. The system comprises:
an acquisition module for acquiring one or more images of a crowd of individuals;
a data processing device 15000 on any one of the embodiments of the second aspect of the invention and configured to receive and process one or more images acquired by the acquisition module.

The acquisition module is of any type suited to the acquisition of one or more images of a crowd. It can be a digital photographic appliance or a digital video camera provided with a digital sensor of CCD or CMOS type.

According to a preferred embodiment, the acquisition module is configured for the acquisition of images of a perspective overhead image of a crowd of individuals. As an example, the acquisition module can be a camera fixed onto a mast at a height of between 1.5 and 5 meters.

### Examples

According to a first exemplary method in accordance with the first aspect of the invention, in step (a), a convolutional neural network CNN of HRNet type is provided, trained on the training set NWPU-Crowd over a little more than approximately 450 periods. Before the training, the annotations of the images of the training set had been subjected to a process of tiling in the form of a Voronoi breakdown in which each cell has for its centroid a single dot of the image representative of the head of an individual. Each cell has then been reduced into a sub-cell separated from the other adjacent cells by a separation zone with a width of 1 pixel. The annotations have been modified by producing an intersection between said annotations and the sub-cells. Then binary images have been created from the modified annotations. These binary images have served as target data for the training of the convolutional neural network.

The method according to this first example is applied to the images of the validation set corresponding to the set NWPU-Crowd. For each of these images, a prediction map is generated in accordance with step (b) of the method. This map is then binarized in accordance with step (c) with a threshold value set at 0.5.

In a comparative example, the method described in Gao et al., “Learning Independent Instance Maps for Crowd Localization”, arXiv preprint arXiv: 2012.04164v3, 2022 is used. The convolutional neural network of HRNT type of this example is trained on the images of the same training set NWPU-Crowd. The images have not undergone any tiling process. The method of this counterexample is then applied to the images of the validation set corresponding to the set NWPU-Crowd.

Table 1 lists the values of NAE, MAE and RMSE in the counting of the heads of the individuals as obtained by the first example E1 according to the invention and the counterexample CE1 on images showing crowds of individuals of different densities: 1 to 24 individuals, 25 to 100 individuals, 101 to 250 individuals, 251 to 500 individuals, and more than 500 individuals.

The NAE is the “normalized absolute error”. The MAE is the “mean absolute error”. The RMSE is the “root mean square error”.

TABLE 1

| | NAE | | | | | | | |
|---|---|---|---|---|---|---|---|---|
| Density | [1, 24] | [25, 100] | [101, 250] | [251, 500] | [501; inf[ | Total | MAE | RMSE |
| CE1 | 0.643 | 0.071 | 0.135 | 0.192 | 0.249 | 0.183 | 66.7 | 249.2 |
| E1 | 0.672 | 0.067 | 0.111 | 0.157 | 0.195 | 0.161 | 54.1 | 206.4 |

The results of Tab. 1 show that, compared to the counterexample method, a method according to the invention allows for a significant average gain of 2.2% over the error NAE in the counting of the individuals. This gain can reach 3.5% for crowds of great density. The gain over the error RMSE reaches 42.8 points. In other words, a method according to the first aspect of the invention is capable of locating and counting individuals that the method according to the counterexample does not permit. It is therefore more reliable and more accurate in the counting of individuals in a crowd, in particular in a dense crowd in which the number of individuals is greater than 25.

### REFERENCES

### Patent Literature

CN 102750539 A, SHENZHEN HIETECH ENERGY TECHNOLOGIES CO LTD, Oct. 24, 2012.
WO 2016 155769 A1, TELECOM ITALIA SPA [IT], Oct. 6, 2016.
CN 107657226 A, UNIV ELECTRONIC SCI & TECH CHINA, Feb. 2, 2018.
CN 116012335 A, SHANDONG UNIVERSITY OF SCIENCE & TECHNOLOGY, Apr. 25, 2023.

### Non-Patent Literature

Gao et al., “Learning Independent Instance Maps for Crowd Localization”, arXiv preprint arXiv: 2012.04164v3, 2022.
Wang et al. “Deep high-resolution representation learning for visual recognition.” IEEE transactions on pattern analysis and machine intelligence 43.10 (2020): 3349-3364.

1. A method, implemented by computer, for locating and counting individuals in a crowd, said method takes, as input data, one or more images of a crowd of individuals, and provides, as output data, one or more binary images of connected components corresponding to heads of the individuals of the crowd, said method comprising:
(a) providing a convolutional neural network (CNN) previously trained on a training set (TDS) composed of images of crowds of individuals whose heads are annotated, the annotations of each image of said training set TDS having previously been modified using a process of tiling as adjacent cells;
(b) generating, for each image of a crowd supplied as input data, a prediction map (PM) by processing said image through the convolutional neural network (CNN) provided in step (a); and
(c) binarizing each prediction map (PM) generated in step (b) using a threshold value (T) or a map of threshold values (TM), each binarized prediction map (BPM) being a binary image of connected components corresponding to the heads of the individuals.

2. The method as claimed in claim 1, wherein, in step (a), the heads of the individuals of the images of the training set (TDS) are annotated using boxes encompassing said heads.

3. The method as claimed in claim 1, wherein, in step (a), the heads of the individuals of the images of the training set TDS are annotated using boxes centered on said heads, sizes of the boxes in superposed condition are reduced such that a distance, d, separating them is greater than a quarter of a smallest dimension, (L-a, L-b, H-a, H-b).

4. The method as claimed in claim 1, wherein, in step (a), the tiling is a Voronoi breakdown.

5. The method as claimed in claim 1, wherein, in step (a), the tiling process further comprises reduction of each adjacent cell into a sub-cell, said sub-cell is inscribed in said adjacent cell and is separated from the other adjacent cells at a boundary between said adjacent cell and the other adjacent cells by a separation zone of a given width.

6. The method as claimed in claim 5, wherein the width of the separation zone is at most 5 pixels.

7. The method as claimed in claim 5, wherein, for each sub-cell, the width of the separation zone is less than or equal to an eighth of the minimum value out of geometrical dimensions of the annotations corresponding to first neighbor adjacent cells of the adjacent cell in which the sub-cell is inscribed, a number of first neighbor cells being at least 3.

8. The method as claimed in claim 5, wherein an area of an intersection of each sub-cell with the annotation associated with the adjacent cell in which said sub-cell is inscribed is greater than or equal to half an area of said annotation.

9. The method as claimed in claim 1, wherein, in step (a), the training of the convolutional neural network CNN further comprises use of an objective function, said objective function includes a penalty parameter associated with pixels of the image situated on common boundaries of the adjacent cells and/or in separation zones between sub-cells.

10. The method as claimed in claim 1, wherein the convolutional neural network (CNN) is an HRNet convolutional neural network.

11. A data processing device comprising:
processing circuitry for locating and counting individuals in a crowd that takes, as input data, one or more images of a crowd of individuals, and provides, as output data, one or more binary images of connected components corresponding to heads of the individuals of the crowd, the processing circuitry being configured to:
provide a convolutional neural network (CNN) previously trained on a training set (TDS) composed of images of crowds of individuals whose heads are annotated, the annotations of each image of said training set TDS having previously been modified using a process of tiling as adjacent cells;
generate, for each image of a crowd supplied as input data, a prediction map (PM) by processing said image through the convolutional neural network (CNN); and
binarize each prediction map (PM) using a threshold value (T) or a map of threshold values (TM), each binarized prediction map (BPM) being a binary image of connected components corresponding to the heads of the individuals.

12. A non-transitory computer readable medium having stored thereon a computer program having instructions which, when the program is run by a computer, cause the computer to implement the method as claimed in claim 1.

13. (canceled)

14. A system for locating and counting individuals in a crowd, said system comprising:
an acquisition module for acquiring one or more images of a crowd of individuals; and
the data processing device as claimed in claim 11 and configured to receive and process one or more images acquired by the acquisition module.

15. The system as claimed in claim 14, wherein the acquisition module is configured for the acquisition of images of a perspective overhead image of a crowd of individuals.

16. The method as claimed in claim 5, wherein the width of the separation zone is at most 2 pixels.

17. The method as claimed in claim 5, wherein the width of the separation zone is at most 1 pixels.

18. The method as claimed in claim 5, wherein a number of first neighbor cells being at least 5.

19. The method as claimed in claim 2, wherein, in step (a), the tiling is a Voronoi breakdown.

20. The method as claimed in claim 3, wherein, in step (a), the tiling is a Voronoi breakdown.

21. The method as claimed in claim 2, wherein, in step (a), the tiling process further comprises reduction of each adjacent cell into a sub-cell, said sub-cell is inscribed in said adjacent cell and is separated from the other adjacent cells at a boundary between said adjacent cell and the other adjacent cells by a separation zone of a given width.
